(19) United States
(12) Patent Application Publication
(10) Pub. No.: US 2008/0244453 A1
(43) Pub. Date: Oct. 2, 2008

(54) ICONIC EVENT TIMELINE WITH LATITUDE SNAPPING AND METHOD FOR PROVIDING THE SAME

(76) Inventor: Jason Edward Cafer, Columbia, MO (US)

Correspondence Address: SPENCER, FANE, BRITT & BROWNE, 1000 WALNUT STREET, SUITE 1400, KANSAS CITY, MO, 64106-2140, US

(21) Appl. No.: 11/933,368

(22) Filed: Oct. 31, 2007

Related U.S. Application Data
(63) Continuation-in-part of application No. 11/695,050, filed on Apr. 1, 2007.

(51) Int. Cl. G06F 3/048

(52) U.S. Cl. 715/835

(57) ABSTRACT

An iconic event timeline for conveying to a user the occurrence of events during a period of time. The iconic event timeline includes a timeline area having an axis representing an interval of time, and a plurality of graphical icons positioned along the axis. Whenever graphical icons representing the same event or class of event occur along the timeline, they occur along the same plane parallel to the axis of the timeline.

### CROSS-REFERENCE TO RELATED APPLICATIONS

This Application is a Continuation-In-Part of U.S. patent application Ser. No. 11/695,050, filed on Apr. 1, 2007, and incorporated by reference herein in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

The present invention related generally to a timeline for conveying information concerning event occurring within a specified time interval, and more specifically to an iconic event timeline utilizing graphical icons to represent events and convey information in a quick and easily understood manner. The present invention also relates to a method of providing such an iconic event timeline and conveying information utilizing the same.

In recent years, health care expenditures in the United States have exceeded $1.9 trillion, and the trend of increasing expenditure shows no sign of slowing. Efforts to manage health care costs have been proposed from time to time, many of which focus on the concept of efficiency. Generally, the greater the efficiency of a health care system, the lower the cost on a per patient basis.

Managed Care Organizations such as, for example, Health Maintenance Organizations (HMOs), embody one attempt to control health care costs. HMOs typically provide a set of care guidelines to the health care providers within the organization's network. A primary care physician often acts as a gatekeeper to other medical services. In theory, efficiency of medical care is increased and the costs of the overall system are lowered. In practice, however, greater efficiency is not always realized. Many attempts to increase medical efficiency are aimed at the administrative processes that make up a large portion of any health care system, rather than at the physician/patient interaction. Inefficiencies that exist at the physician/patient level are an important target area for increasing the efficiency and lower the per-patient cost of health care.

Medical records, also referred to as medical charts, are vital to the health care professions. Each medical record represents a systematic documentation of a patient's medical history and current care. Over the years, the amount and quality of patient information contained within a medical record has increased. The value of the medical record to the health care professional has undergone a corresponding increase, and because of the value of the medical record, health care professionals spend an increasing amount of time either entering information into a patient's medical record or reviewing information already contained therein. The time spent by a health care professional accessing, editing, or reviewing medical records limits the time available to the professional for other tasks, including face-to-face patient contact.

It is estimated, for example, that mental health professionals spend approximately forty percent of their time documenting patient data in a medical record, and another fifteen percent of their time retrieving data concerning individual patients from the medical record. Thus, for any given patient, a mental health professional typically spends more than one-half of the available time interacting in some way with the medical record rather than the patient. This practice tends to be repetitive and inefficient.

As the sophistication of electronic technologies has increased, such technologies have been used to address efficiencies in accessing medical records. Difficulties have remained, however, in part due to the failure to adapt traditional thinking to the modern electronic environment. Many electronic medical records systems have essentially ported the traditional medical record to an electronic environment, with little or no adaptation of the medical record to take advantage of this new environment. This had led to some increase in efficiency in terms of accessing medical records and, to some extent, navigating the information contained therein. Many of the other inefficiencies of the traditional medical record, however, remain unaddressed. In some cases, many existing electronic medical records may even be less effective than traditional paper charting. It has been estimated that at least fifty percent of physicians enter text results into an electronic record by cutting and pasting patient data from other portions of the electronic record. This leads to an increase in text volume in the record, often making the information less accurate and more difficult to retrieve than information contained within traditional paper charts. An estimate published in the Journal of the American Medical Association found that ninety percent of text in standard electronic medical records is either redundant or inaccurate (Hirschtick, JAMA 295:2335-2336, 2006). Even with respect to accurate information, accessing the desired components of an electronic medical record often requires unnecessary mouse-clicks and keystrokes, due to inefficient presentation of the record.

The health care professions represent but one exemplary field wherein inefficiencies in information presentation contribute to unnecessary costs in terms of time, money, and resources. This is particularly true when the information is of a historical nature and may span a lengthy period of time. What is needed, therefore, is a timeline that allows for quick and easily understood conveying of historical information to an individual.

### BRIEF SUMMARY OF THE INVENTION

An iconic event timeline for conveying to a user the occurrence of events during a period of time. The iconic event timeline includes a timeline area having an axis representing an interval of time, and a plurality of graphical icons positioned along the axis. Whenever graphical icons representing the same event or class of event occur along the timeline, they occur along the same plane parallel to the axis of the timeline.

In another aspect of the present invention a positive event area is included for displaying at least one graphical icon associated with an event, the time of occurrence of said event being unknown for the interval of time represented by said axis.

In still another aspect of the present invention a negative event area is included for displaying at least one graphical icon not displayed in said timeline area.

In another aspect of the present invention an all event area is provided for displaying all graphical icons available for use with said iconic event timeline.

In another aspect of the present invention an unknown event area is provided for displaying at least one graphical icon associated with an event the occurrence of which is unknown for the interval of time represented by said axis.

In another aspect of the present invention the iconic event timeline is displayed via a graphical user interface and the graphical icons can be manipulated by a user.

In another aspect of the present invention the graphical icons displayed via a graphical user interface automatically snap to an appropriate plane parallel to the axis of the timeline area after the graphical icons are manipulated by the user.

In another aspect of the present invention text content is associated with the graphical icons, the text content providing details associated with the event represented by the graphical icons.

In another aspect of the present invention the invention is provided via a computer system in electronic communication with a database, the system adapted to automatically retrieve information from the database for association with the graphical icons of the present invention, or to automatically update the database based on manipulation of the graphical icons by a user.

These and other aspects of the present invention will be apparent upon reading the description that follows.

### BRIEF DESCRIPTION OF THE DRAWINGS

FIG. 1 is a schematic representation of an iconic event timeline of the present invention.

FIG. 2 is a schematic representation of an all event area and unknown event area associated with an iconic event timeline of the present invention.

FIG. 3 is a diagram of an alternative embodiment of an iconic event timeline of the present invention.

FIG. 4a depicts an alternative representation of one embodiment of an iconic event timeline of the present invention, the line shown in locked form.

FIG. 4b depicts an alternative representation of a line on one embodiment of an iconic event timeline of the present invention, the line shown in unlocked form.

### DETAILED DESCRIPTION OF THE INVENTION

Before turning to a detailed description of each of the present invention, basic hardware and software information is now provided. The present invention may be implemented on any suitable computer or other device, which may include but is not limited to a desktop personal computer, a laptop or notebook computer, a server-type computer system, or a personal digital assistant. Any suitable computer system may be used to run software developed in accordance with the present invention. Likewise, any suitable computer operating system may be used to run software developed in accordance with the teachings of the present invention. Such operating systems include, but are not limited to, any of the various versions of Microsoft Windows, MacOS, Linux distributions, and OS/2. Finally, it will be apparent to those of skill in the art upon reading this disclosure that the teachings of the present invention can be implement using any of a variety of computer programming languages. It is contemplated that any suitable language may be used and that the use of one rather than another does not depart from the spirit or scope of the present invention. Examples of programming languages that may be used include, but are not limited to, Java, C, C++, BASIC, Visual Basic, Python, COBOL, ASP, Perl, .NET, PHP, and combinations thereof.

The present invention may be implemented via a web-based software application, a stand-alone software application, or a combination of both. The various features of the present invention that require a degree of networking may utilize an established wide-area network, such as the internet, or may run entirely on a local-area network (LAN) or via dedicated network lines that, while not local, are directed exclusively toward implementation of the present invention. Any suitable network type may be used in conjunction with the present invention.

As used herein, the word system denotes the system of conveying information using the teachings of the present invention, and is also used to refer to a system in which the present invention is implemented, which refers to any hardware or software utilized to implement the teachings of the present invention. It is contemplated that those of skill in the art will be able to implement the present invention across a variety of hardware and software systems upon reading this disclosure. It is further contemplated that aspects of the present invention may be provided on a durable medium, such as for example paper, rather than implemented on a computer system.

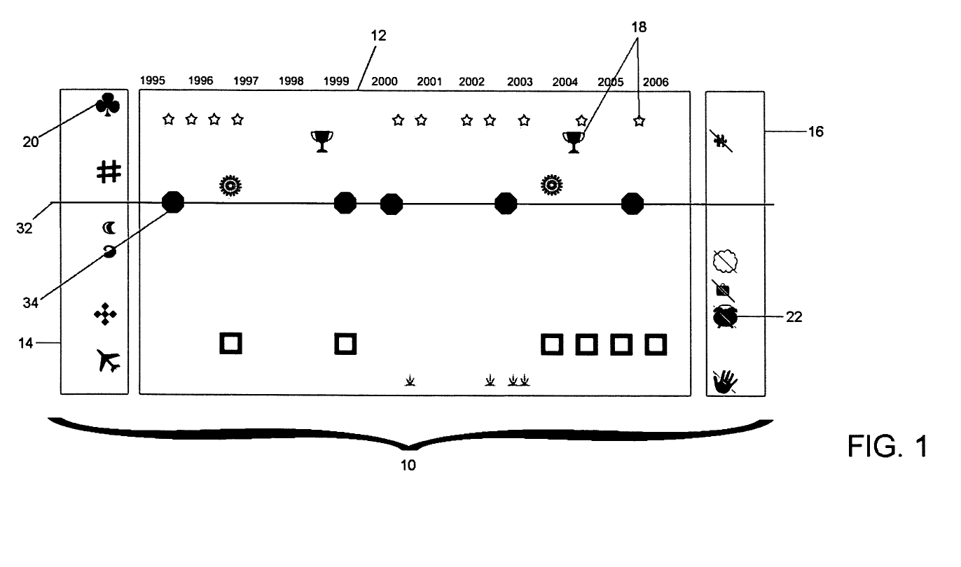

Turning now to the drawings, the present invention is directed to an iconic event timeline, a method of producing an iconic event timeline, and a method of conveying information using the same. FIG. 1 shows generally an iconic event timeline 10 having three general areas included therewith. The three areas are timeline area 12, positive event area 14, and negative event area 16.

Timeline area 12 spans a timeline of interest and displays one or more event icons 18 along, for example, a length of timeline area 12. Event icons 18 represent events of interest occurring during the time period represented by timeline area 12. These events of interest may, for example, include significant medical or personal events, world events, or any other event of interest to a user of the present invention. It is preferred that for each individual event represented by individual event icons 18, a different graphical icon is used as an event icon 18. For example, in the case of a medical timeline a graphical icon that approximates a pill or other medicament may represent the initiation of a prescribed medical treatment. Likewise, a graphical icon approximating a first-aid symbol may be utilized to indicate a hospital visit. Any suitable image may be used for any given graphical icon 18 or class of graphical icons 18. The specific images used may vary widely across embodiments or implementations of the present invention, and each variation may serve equally well as a user of the present invention will come to identify with specific images used for graphical icons 18 with the specific events represented by the same. It is contemplated that timeline area 12 may span an interval of time in a uniform manner, or may be expanded or contracted at points along an axis thereof where details contained within timeline area 12 for that specific time interval may be expanded or contracted. The direction in which time is displayed along a length of timeline area 12, from a more distant time to a more recent time, is referred to herein as, among other things, an axis of timeline area 12. When the interval of time along the axes if timeline area 12 does not uniformly span the axis (i.e. when certain areas of timeline area 12 are expanded or contracted or both) the axis is referred to as a non-uniform axis.

FIG. 1 also displays positive event area 14, located in the figure to the left of timeline area 12, although positive event area 14 may be positioned in any suitable manner. Positive event area 14 includes graphical icons 20, which represent events of interest relating to the subject (a patient, for example, in embodiments of the present invention adapted for use in the medical fields) of timeline area 12. As with graphical icons 18, it is preferred that the images used for graphical icons 20 bear some relationship to the event being indicated by graphical icons 20, although any suitable image or images may be used. Graphical icons 20 contained in positive event area 14 preferably represent events that are none to have occurred, but for which a specific (or even general) time of occurrence is unknown or is irrelevant to the user of the present system. It is possible that for any given application of the present system, there will be no graphical icons 20 associated with positive event area 14, in which case positive event area may simply be shown as empty or may be hidden altogether. A given graphical icon may, however, be represented in both timeline area 12 and positive event area 14, indicating that one or more occurrence of the event associated with that particular graphical icon is known, while one or more separate occurrences of the same event are unknown or irrelevant in terms of the time at which they took place.

Also shown in FIG. 1 is negative event area 16, shown in the figure as being positioned to the right of timeline area 12, although negative event area 16 may be positioned in any suitable manner. Negative event area 16 includes graphical icons 22, which represent events of interest relating to the subject of timeline area 12. As with graphical icons 18 and 20, it is preferred that the images used for graphical icons 22 bear some relationship to the event being indicated by graphical icons 22. It is contemplated, however, that any suitable image or images may be used. Graphical icons 22 contained in negative event area 16 preferably represent events that have never occurred with respect to the subject of timeline area 12. In the instance wherein the present invention is used in the medical field, for example, a graphical icon 22 representing a broken bone may be located in negative event area 16 to indicate that a patient whose history is being displayed in timeline area 12 has never experienced a broken bone. It should be noted that while graphical icons 22 located in negative event area 16 preferably represent events that have never occurred with respect to the subject of timeline area 12, graphical icons 22 may also represent events that have occurred by have be represented by the subject of timeline area 12 as not having occurred. In the case of a patient undergoing mental health care, for example, events that a patient has misrepresented as not having occurred would be represented by graphical icons 22 in negative event area 16. It is contemplated that when a graphical icon is dragged from negative event area 16 (as described below) or otherwise placed in either of positive event area 14 or timeline area 12, the corresponding graphical icon is automatically removed from negative event area 16.

As shown in FIG. 1, timeline area 12 includes multiple horizontal planes extending along a length thereof. It is preferred that al graphical icons representing the same event (or, in some embodiments of the present invention, the same class of event) be displayed in timeline area 12 along the same horizontal plane. Horizontal plane 32, for example, includes five graphical icons 34, each of which are identical and therefore represent the same event or class of events. Thus, when a user of the present invention desires to quickly view and assimilate information concerning the occurrence of a particular event or class of events, the user need only pay attention to a single horizontal plane of timeline area 12 rather than studying timeline area 12 as a whole in order to mentally separate the desired events from non-desired events. A class of events may be any suitable grouping of events such as, for example, all surgeries, hospitalizations, psychiatric hospitalizations, arrests, child births, and the like. Any suitable class may be defined for use in conjunction with the present invention.

In addition to positioning graphical icons representing the same event, or the same class of events, on a single horizontal plane in timeline area 12, it is further contemplated that graphical icons 20 and 22, located in positive event area 14 and negative event area 16, respectively, are also located along the same horizontal plane as graphical icons representing the same event or class of events in timeline area 12 (or in the case of graphical icons 22 in null area 16, along the horizontal plane upon which they would be displayed in timeline area 12, were the event or events represented in timeline area 12).

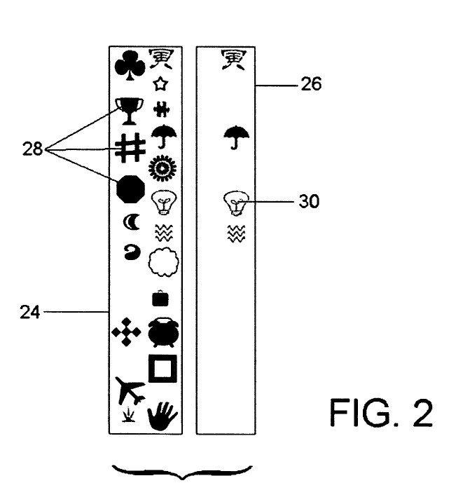

FIG. 2 provides an illustration of two additional areas that may be displayed along with iconic event timeline 10. These additional areas are preferably positioned such that graphical icons associated therewith are located along the same horizontal plane as the same, or same class of, graphical icons displayed in timeline area 12. All event area 14 preferably displays all graphical icons associated with a given implementation of the present invention, thereby providing a user with a view of all of the graphical icons 28 that may be also represented somewhere on timeline area 12, in positive event area 14, or in negative event area 16. Unknown event area 26 preferably displays all graphical icons 30 for which is it unknown or irrelevant whether the associated event occurred. Graphical icons 30 are preferably those graphical icons that are available for use with the implementation of the present invention (and therefore displayed in all event area 24), but are not displayed in any of timeline area 12, positive event area 14, or negative event area 16.

It is preferred that the present invention be implemented via a graphical user interface (GUI), such as a GUI associated with a desktop or laptop computer or other device. While a paper embodiment may be produced such as, for example, by printing an iconic event timeline 10 being displayed via a GUI or creating such a timeline directly on paper, the implementation of the present invention via a GUI allows for added functionality and ease of use.

When the present invention is displayed via a GUI, for example, a user of the present invention may directly manipulate iconic event timeline 10. Iconic event timeline 10 may be manipulated by, for example, positioning a mouse cursor over any portion of iconic timeline 10, thereby retrieving additional information about the area of iconic event timeline 10 over which the cursor is positioned (as described more fully below). A user may also use a mouse or other device to drag graphical icons from positive event area 14, negative event area 16, all event area 24, or unknown event area 26 onto timeline area 12. Once an icon has been dragged to timeline area 12, it automatically snaps to the appropriate horizontal plane, the horizontal plane being determined as described above. Graphical icons may also be dragged from all event area 24, unknown event area 26, or timeline area 12 into either of positive event area 14 or negative event area 16. It is contemplated, in fact, that graphical icons may be dragged from any one area to any other area, whereupon the graphical icon will be displayed in that area to which it has been dragged and automatically snap to the appropriate horizontal plane.

Use of the present invention provides a number of advantages to the user. A user of the present invention may, for example, quickly scan iconic event timeline 10 in order to determine whether or not an event has occurred with respect to the subject of iconic timeline 10 within the time interval represented by timeline area 12 by locating the appropriate graphical icon within iconic event timeline 10. Further, because other events represented by other graphical icons are also displayed within timeline area 12, a user will not only be able to quickly ascertain the time (generally or specifically, depending on the time interval covered by timeline area 12), but also determine the context surrounding the event as represented by the other graphical icons appearing on or around the same time period.

A user of the present invention may also quickly scan negative event area 16 in order to determine whether an event has occurred with respect to the subject of iconic event timeline 10 over the time interval represented by timeline area 12. Any event represented by a graphical icon appearing in negative event area 16 will not be represented in either of timeline area 12 or positive event area 14. Thus, a user can quickly assimilate information concerning events that have not occurred. It is expected that over the course of using the present invention, a user will become accustomed to the horizontal plane associated with any given graphical icon (and therefore any given event or class of events), and will therefore be able to even more readily ascertain the occurrence or non-occurrence of any given event or class of events. Furthermore, by scanning timeline area 12 from right to left, in a typical embodiment of the present invention, a user will be able to ascertain those events that have occurred more recently as opposed to distant occurrences.

It is contemplated that in many instances multiple occurrences of the same event will be represented within iconic event timeline 10. In such situations, any suitable method of positioning or displaying multiple graphical icons of the same type may be used. It is contemplated, however, that a user may copy an icon already being displayed within iconic event timeline 10 (such as by using conventional computer functionality such as right-clicking or using ctrl-c) and then paste that graphical icon to another position along a length of timeline area 12. The newly pasted icon will snap to the same horizontal plane as other of the same graphical icons, but will be represented at a different point in time indicating a separate occurrence of the same event.

As noted above, graphical icons may be placed within iconic event timeline 10 by direct manipulation of the graphical icons by a user of the present system (such as via a GUI). It is contemplated, however, that the present invention may be adapted to communicate electronically with a database containing information that may be assimilated by the present invention and automatically displayed appropriately within iconic event timeline 10. In situations wherein the present invention is applied to the medical field, for example, the present invention may be adapted for use in conjunction with a computer system that is in electronic communication with a personal health record, electronic medical record, or other database containing medical information regarding the subject of iconic event timeline 10. The present invention may be implemented in such a manner that it automatically retrieves such information, or the personal health record, electronic medical record, or other database may be associated with a program adapted to send such information to the computer system with which the present invention is being implemented. It is further contemplated that the initial configuration of iconic event timeline 10 may be performed based on the results of a questionnaire (electronic or otherwise) answered by the subject of iconic event timeline 10. Again using the medical field as an example, a patient may answer a pre-visit questionnaire prior to being seen by a physician or other health care professional, and the answers to the questionnaire may be assimilated by the present invention and the appropriate corresponding graphical icons and time intervals displayed via iconic event timeline 10. Once an initial iconic event timeline 10 is established, the iconic event timeline 10 pertaining to a given subject may also be update in the same automated manner.

While the present invention as described above provides a great deal of information in a manner that is easy to understand and assimilate by a user of the present invention, it is contemplated that in some embodiments of the present invention, text information may also be provided to supplement the information provided by the graphical components of the invention. For example, text content may be associated with each graphical icon represented in iconic event timeline 10. A user may access the text content by, for example, positioning a mouse cursor over any graphical icon represented in iconic event timeline 10 (although the text content may be accessed in any suitable way). The text content associated with any given graphical icon may provide details pertaining to the event represented by that graphical icon. These details may be entered into a system in which the present invention is being implemented, or they may be entered by a physician, health care professional, or other evaluator or individual authorized to do so. Text content may also be retrieved automatically by a system in which the present invention is being implemented, such that it is automatically associated with a corresponding graphical icon. Thus, text information contained in a personal health record or electronic medical record may be automatically associated with the appropriate graphical icon displayed in iconic event timeline 10. It is further contemplated that in some embodiments of the present invention the text information displayed in associated with a given graphical icon may be altered by an authorized user of the present invention, and that when such an alteration takes place a system in which the present invention is being implemented automatically updates the database from which the text information was retrieved. Thus, using the medical field as an example, a change to textual information associated with a graphical icon made by an authorized user of the present invention would result automatically in a corresponding change in an associated personal health record or electronic medical record. In addition, manipulation by an authorized user of the graphical elements of the present invention, such as the graphical icons associated therewith, preferably results in the automatic updating of an associated database to include new information provided to the system as a result of the graphical manipulation. In the medical field, for example, placing a new graphical icon in timeline area 12 preferably results in an update being automatically written to a personal health record or electronic medical record. In such instances, the changed database may also record the identity of the user who initiated the change, as well as the time and date of the change.

While preferred shapes and layouts of iconic event timeline 10 are shown in figures and described herein, it is contemplated that the principles of the present invention may be applied to various graphs of varying types, including line graphs and the like, and that the various areas described herein may be displayed in any suitable layout or arrangement that still provides the functionality of the present invention.

An example of one aspect of the present invention adapted for use with the medical field is now provided. Timeline area 12, in this aspect of the present invention, includes a graph referred to alternately as a Life Timeline T or as patient history graph 502.

A timeline such as the Life Timeline T or patient history graph 502 is invaluable to a health care provider and, in particular, to a psychiatric provider. Even a relatively crude, handwritten timeline is an asset. Despite the value of such timelines, they are rarely used in, for example, the psychiatric profession, due to the amount of time required to construct the timelines. The present invention provides a timeline in the form of patient history graph 502 that requires a relatively small amount of time on behalf of the patient and, preferably, no time on the part of the provider for the initial construction of patient history graph 502. Preferably, patient history graph 502 is constructed initially entirely from a pre-visit electronic questionnaire completed by a patient. In some embodiments of the present invention, a patient may be given access to the system such that they are able to construct their own patient history graph 502 “from scratch.” It is preferred that such patient receive training on how to use a system implementing the present invention prior to constructing their own patient history graph 502. Construction of a patient history graph by a patient can be accomplished by, for example, dragging lines, placing event icons, typing text related to event icons directly, and the like. The patient can preferably view patient history graph as it would be seen by a user of the present system in order to ensure that information is accurately placed. Further, during the course of, for example, a teleconference visit, a user may allow placement of patient history graph 502 on the patient's screen, either as a “view only” graphic or a corresponding dashboard that the patient may alter by some or all methods (click, drag, text entry, and the like) available to the user. These changes to the dashboard made by a patient may be saved on the dashboard if the user authorizes such a save. If electronically signed by a user, these changes are preferably automatically entered into an electronic medical record, personal health record, or other database in electronic communication with a system in which the present invention is implemented, marked by the date of the change and the identity of the person making the change (the patient in this example).

After initial construction of patient history graph 502, patient history graph 502 is updated over time in various ways. As the patient continues to receive services, for example, subsequent questionnaires may be used to supplement the initial material in patient history graph 502. Further, data obtained via the patient's PDA or other symptom-tracking device is also incorporated into patient history graph 502.

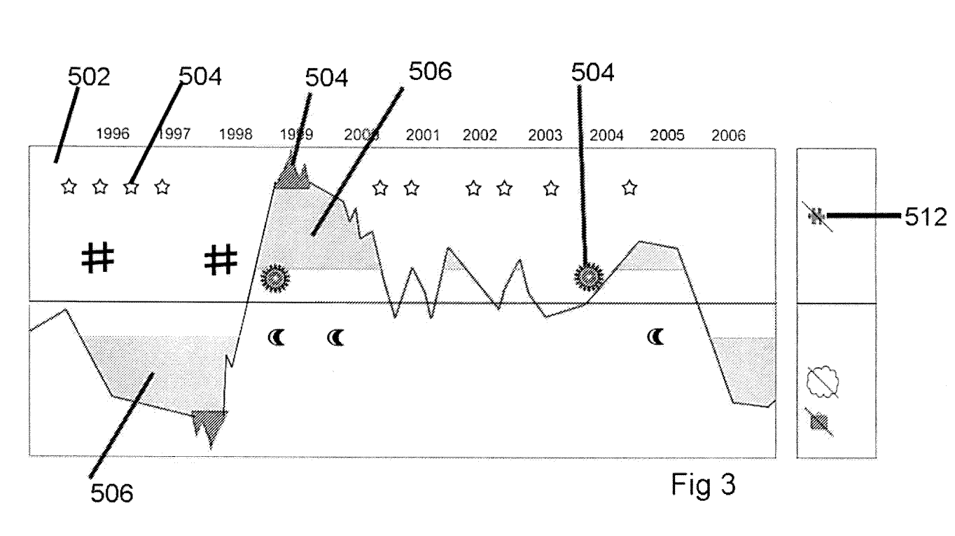

An embodiment of patient history graph 502 is shown in more detail in FIG. 3 and described now.

The embodiment of patient history graph 502 or iconic event timeline shown in FIG. 3 is preferably utilized in a psychiatric or psychotherapeutic setting, and includes not only the medical history of a given patient but a history of social and psychological events over the course of the “Life Timeline™.” Such events are represented by event icons 504. Event icons 504 are preferably easy to understand graphical representations that signify the occurrence of certain events or event types at various times over the course of the patient's life. While certain specific graphical event icons 504 are shown in the figure, it is contemplated that any suitable icon may be used to represent any given event.

It is contemplated that a user of the present system is able to move graph lines by, for example, manipulating the graph lines with a mouse or via a touch screen. The movement of graph lines on patient history graph 502 represents a dashboard alteration, and any alteration of a previously electronically signed dashboard is archived in the official medical record, or as a note or addendum to the original note where the data corresponding to that dashboard representation was documented.

Event icons 504 are preferably separated into four primary categories: 1) psychological events; 2) medical events; 3) social events; and 4) substance events. Psychological events may include, for example, periods of depression or anxiety, or periods of suicidal thoughts or behaviors. Medical events may include such events as surgeries, allergic reactions, major injuries, and the like. Social events may include schooling, marriage or divorce, arrests, physical altercations, and the like. Substance events are those events related to substance abuse, such as drug or drinking events, entering rehabilitation for drugs or alcohol, and the like. Any life events deemed important by a user of the present system may be adapted for inclusion, as an event icon 504, in patient history graph 502.

As can be seen in FIG. 3, each specific event icon 504 occupies its own horizontal plane on patient history graph 502. It is preferred that this plane remain constant, at least with respect to any given user of the present system, so that the user may quickly identify any given life event or event type by looking immediately along the appropriate horizontal plane during a session with a patient. In order to further provide information as efficiently as possible, null icons 512 are also provided, preferably along a right-hand side of patient history graph 502. Null icons 512 represent events that are not applicable to the patient whose history is being represented in patient history graph 502 (serving a function similar to that served by negative event area 16 in other embodiments of the present invention described above). Thus, a provider is immediately able to rule out certain areas of concern with respect to the patient's history, such as whether the patient has ever attempted suicide, by looking to null icons 512 for inclusion of a suicide-related icon among them. In a preferred embodiment of the present invention, adjacent patient history graph 502, is a space provided (not shown in the figures) for placement of icons relating to events that are reported to have occurred, but have not had an estimated timeframe attributed thereto. These icons, therefore, are not located on patient history graph 502. In a preferred embodiment of the invention, this space is provided to the left of patient history graph 502, and icons placed therein snap to the appropriate horizontal plane as if they had been placed on patient history graph 502.

Event icons are preferably most often placed by either a user of the present system, or by the patient to whom a given patient history graph 502 pertains. The patient places icons primarily via a pre-visit electronic questionnaire or through event reporting using, for example, the first-on PDA symptom reporting feature of the present invention. A user of the present system may place icons in various ways. In one embodiment of the present system, for example, right-clicking with a mouse or performing another action while viewing a patient history graph 502 results in the display of a menu containing event icons 504 or text descriptions corresponding to event icons 504. A user of the present system is able to drag event icons 504 from the menu to the appropriate horizontal position (representing a specific temporal position) on patient history graph 502. The vertical position to which event icon 504 is dragged is immaterial because event icon 504 preferably snaps to the appropriate vertical plane after being dragged onto patient history graph 502. Alternatively, a user of the present system may drag one or more of null icons 512 onto patient history graph 502. By so doing, the user essentially converts a null icon 512 into an event icon 504. The newly converted event icon 504 is dragged to the appropriate horizontal location on the patient history graph 502 where it is released and whereupon it snaps into the appropriate vertical plane. The specific null icon 512 that was dragged onto patient history graph 502 and converted into an event icon 504 disappears from the group of null icons 512 that are provided preferably along a right-hand side of patient history graph 502. Further alternatives for placing event icons 504 include placement using a specialized keyboard (such as, for example, the Optimus™ keyboard described below), via the use of voice recognition software, or via any other suitable means of placing and appropriate event icon 504 at an appropriate location along patient history graph 502.

In addition to event icons 504, shaded areas 506 are also preferably provided in patient history graph 502. Shaded areas 506 represent certain predetermined ongoing issues in a patient's history, and preferably also represent the severity of the issue. For example, a patient's general level of anxiety may be tracked over a given time period. This tracking over time may be represented by a line graph covering the appropriate time period. The anxiety level is represented as being higher or lower depending on the vertical height of the line. The area beneath the line is preferably shaded in order to provide an easy, efficient representation of this information to the user, who need only glance at the graphed line and shaded area to understand the time period of anxiety and the severity of the anxiety over the course of the time period. The user may preferably select whether the shading is located above or below the line, and to what latitude the shading extends.

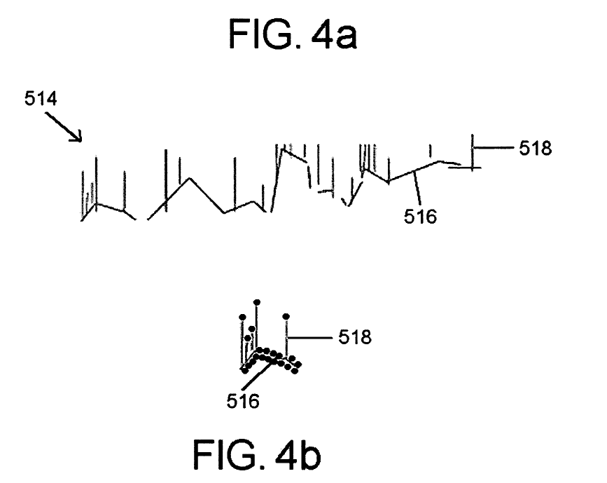

FIGS. 4a and 4b provide an alternative embodiment of a graphic line representation included in patient history graph 502. A line graph 514 such as that shown in the figure may be accessed or displayed using the present system by, for example, selecting the appropriate options or settings in the software of the present system, or by right-clicking on an existing line in the normal patient history graph 502 and choosing to display a line thereon in the manner shown in FIG. 4a. Line graph 514 provides an efficient, easy to read linear representation of desired data from patient history graph 502. In the exemplary line graph 514 shown in FIG. 6a, for example, horizontal line 516 indicates hours of nightly sleep obtained by a patient over time. Vertical lines 518 indicate hours of nap time obtained by that same patient on any given day. Thus, line graph 514 provides an efficient, easy to read representation of the sleeping habits of the patient to whom line graph 514 pertains. The embodiment of line graph 514 shown in FIG. 4a represents line graph 514 in locked form, where the data provided by line graph 514 is displayed but cannot be manipulated by a user of the present system. Alternatively, the embodiment of line graph 514 shown in FIG. 4b represents line graph 514 in unlocked form, wherein a user may click and drag the various lines 516 and 518 in order to edit the information represented by each of these lines upon, for example, obtaining new information from the patient to whom line graph 514 pertains.

Patient history graph 502 preferably spans the entire lifetime of a given patient, from birth until the date at which a provider is making use of the graph, and even extends into the future if future events such as a wedding, surgery, or other known future event is entered into patient history graph 502. The patient's date of birth is preferably provided in an upper left-hand corner of the graph. From there, patient history graph 502 extends from left to right on the screen, with spatial movement to the right representing temporal movement over the course of the patient's lifetime. Patient history graph 502 then ends at the current date, which is preferably displayed in an upper right-hand corner of the graph.

Because patient history graph 502 encompasses the entire lifetime of a given patient, it is preferred that various levels of compression exist from left to right across the chart. As shown in FIG. 3, for example, the area encompassing the first fifteen years of a patient's life may be highly compressed, such that only a small amount of horizontal space is occupied by this time period. In this compressed portion 514, major events are preferably still indicated by event icons 504, but the compression of this portion of patient history graph 502 results in the provision of less information than other less compressed portions of the graph. The age period from sixteen to twenty-five, for example, may be less compressed than that from birth to age fifteen. In the example shown in the figure, the age of sixteen may be chosen as a starting place for a less compressed graph due to the occurrence of major events around that time, events that have an impact on the current treatment and care of the patient. In this moderately compressed portion 516 of patient history graph 502, more information is provided than in compressed portion 514. More event icons 504 are included, and the lesser compression allows for more information to be imparted in the form of line graphs and the like. As shown in FIG. 3, the time period of the patient's life from age twenty-five to the present is represented in uncompressed form. Uncompressed portion 518 provides the greatest level of detail of any portion of patient history graph 502. The point at which patient history graph 502 presents information in uncompressed form may be chosen to coincide with a major life event, such as a death, that correlates with symptoms or diagnoses of that patient. Event icons 504 are more easily correlated with the timeline, in order to obtain a more accurate representation of when the represented events occurred, and line graphs and the like are able to provide an increased level of information because of the uncompressed nature of the data.

Patient history graph 502 further preferably includes a compression bar 520 located along a perimeter thereof. Using a mouse, a user of the present system may slide compression bar 520 along patient history graph 502 and alternatively compress or decompress various regions of patient history graph 502. Thus, a user of the present system may expand the level of detail for any given time period in the patient's life, while correspondingly compressing the level of detail for other time period. In this way a user of the present system is able to focus on a particular time period in a patient's life. It is preferred that when patient history graph 502 is compressed as described above, size and shape of event icons 504 remain the same. Thus, a user of the present system is able to quickly identify events occurring even over the compressed portions of patient history graph 502.

It is further preferred that patient history graph 502 is provided in layers, with a user of the present system having the ability to designate which layers are displayed at any given time. Each layer may contain, for example, event icons only, graph lines only, or a combination of event icons and graph lines. A user may specify the transparency and visibility of each line and icon independently of the layer in which the icon or graph line resides.

In addition to the above, it is contemplated a user of the present system may use a mouse, computer keyboard, or other input device to select given areas of patient history graph 502, or select the entire graph, and manipulate it such as, for example, by rotating the graph, shrinking or expanding the graph or any region thereof, or in any other way desired by the user.

In additional aspects of the present invention, addition functionality is provided. In one aspect of the present invention, for example, the graphical icons associated with the present invention may be placed on an electronic medical record or patient chart. In another aspect of the present invention, a physician, health care professional, or other authorized user may remove or modify graphical icons previously placed on a timeline or in an electronic medical record by a patient using iconic event timeline 10. The appearance of the graphical icons associated with the present invention, including design, size, shape, color, or image represented, may also be customized by users of the present invention, who may upload substitute icons into a system in which the present invention is being implemented, for use in addition to or instead of the graphical icons initially supplied in association with the present invention. The user may add entirely new graphical icons to the functionality of the present invention, or choose from among alternatives provided in association with the present invention. Further, a physician, health care professional, or other user may customize the specific latitude or plan to which a set of same graphical icons, or same class of graphical icons, snap when placed on iconic event timeline 10.

It is contemplated that upon reading this disclosure one of skill in the art could reasonably adapt the principles of the present invention to various other art areas, and such uses of the principles of the present invention are considered to be within the spirit and scope of the present invention. In such other systems, the individual analogous to the ‘patient,’ referred to above with respect to health care-related embodiments of the present invention, may be referred to as the ‘client’ of a user of said system.

The detailed description set forth above is provided to aid those skilled in the art in practicing the present invention. The invention described and claimed herein, however, is not to be limited in scope by the specific embodiments disclosed because these embodiments are intended to be illustrative of several aspects of the invention. Any equivalent embodiments are intended to be within the scope of the present invention. Various modifications of the invention that do not depart from the spirit or scope of the present invention, in addition to those shown and described herein, will become apparent to those skilled in the art from the foregoing description. Such modifications are also intended to fall within the scope of the appended claims.

1. An iconic event timeline for conveying to a user the occurrence of events during a period of time, the iconic event timeline comprising:
a) a timeline area having an axis representing an interval of time; and
b) a plurality of graphical icons positioned along said axis of said timeline and along at least one plane parallel to said axis, said plurality of graphical icons representing a plurality of events,
wherein all occurrences of graphical icons of said plurality of graphical icons relating to a same event are displayed along the same plane parallel to said axis.

2. The iconic event timeline of claim 1 further wherein all occurrences of graphical icons of said plurality of graphical icons representing a same class of event are displayed along the same plane parallel to said axis.

3. The iconic event timeline of claim 1 further comprising a positive event area for displaying at least one graphical icon associated with an event, the time of occurrence of said event being unknown or irrelevant for the interval of time represented by said axis.

4. The iconic event timeline of claim 1 further comprising a negative event area for displaying at least one graphical icon not displayed in said timeline area.

5. The iconic event timeline of claim 1 further comprising an all event area for displaying all graphical icons available for use with said iconic event timeline.

6. The iconic event timeline of claim 1 further comprising an unknown event area for displaying at least one graphical icon associated with an event the occurrence of which is unknown for the interval of time represented by said axis.

7. The iconic event timeline of claim 1 wherein said iconic event timeline is displayed via a graphical user interface, and further wherein said plurality of graphical icons can be manipulated by a user of said iconic event timeline.

8. The iconic event timeline of claim 7 wherein said plurality of graphical icons automatically snap to an appropriate plane parallel to said axis of said timeline area after manipulation of said plurality of graphical icons by said user.

9. The iconic event timeline of claim 1 further comprising a text content associated with said plurality of graphical icons, said text content providing details associated with the event represented by said plurality of graphical icons.

10. The iconic event timeline of claim 9 wherein said iconic event timeline is provided via a computer system, said computer system adapted to automatically retrieve said text information from an electronic database in electronic communication therewith.

11. The iconic event timeline of claim 9 wherein said text content may be altered by an authorized user of said iconic event timeline.

12. The iconic event timeline of claim 10 wherein said text content may be altered by a user of said iconic event timeline, and further wherein alterations by said user are transmitted to said electronic database for the updating thereof.

13. The iconic event timeline of claim 10 wherein alterations to said electronic database are automatically reflected in iconic event timeline 10.

14. A method of conveying information to a user, the method comprising the steps of:
a) providing a user with a timeline having an axis representing an interval of time;
b) displaying a plurality of graphical icons positioned along said axis of said timeline and along at least one plane parallel to said axis, said plurality of graphical icons representing a plurality of events,
wherein all occurrences of graphical icons of said plurality of graphical icons relating to a same event are displayed along the same plane parallel to said axis.

15. The method according to claim 14 further wherein any of plurality of graphical icons representing a same class of event are displayed along a same plane parallel to said axis.

16. The method according to claim 1 wherein said graphical icons are selected from graphical icons relating to a category selected from the group consisting of psychological events, medical events, social events, and substance events.

17. The method according to claim 7 wherein said interval of time represented by said axis of said timeline area may be expanded or contracted by manipulation of said axis by a user of said iconic event timeline.

18. The iconic event timeline according to claim 5 wherein said graphical icons displayed in said all event area represent all available events associated with said iconic event timeline.

19. The iconic event timeline according to claim 1 wherein said axis is a non-uniform axis.

20. The method according to claim 14 further comprising the step of displaying said plurality of graphical icons in a patient medical record.

21. The method according to claim 14 further comprising the step of displaying said plurality of graphical icons on an electronic device selected from the group consisting of PDAs, cell phones, smart phones, and electronic diary devices.

22. The iconic event timeline according to claim 7 wherein said plurality of graphical icons manipulated by a user of said iconic event timeline may be further manipulated by a health care professional authorized to manipulate said graphical icons.

23. The iconic event timeline according to claim 1 wherein said iconic event timeline is located in a patient medical chart, and further where said interval of time is the lifespan of a patient to whom said patient medical chart pertains.

24. The iconic event timeline of claim 8 wherein said plane parallel to said axis to which said plurality of graphical icons snap is customized by a user of said iconic event timeline.
